(19) United States
(12) Patent Application Publication
(10) Pub. No.: US 2002/0097276 A1
(43) Pub. Date: Jul. 25, 2002

(54) Device for offering information

(76) Inventors: Bodo Paulke, Kleinsendelbach (DE); Mohsen Shafaei, Baiersdorf (DE)

Correspondence Address: SCHIFF HARDIN & WAITE, 6600 SEARS TOWER, 233 S WACKER DR, CHICAGO, IL, 60606-6473, US

(21) Appl. No.: 10/016,239

(22) Filed: Dec. 11, 2001

(30) Foreign Application Priority Data
Dec. 14, 2000 (DE) 10062351.4

(51) Int. Cl. G09G 5/00

(52) U.S. Cl. 345/841; 345/835; 345/748

(57) ABSTRACT

In a device for offering information, a network allows a connection to be set up between a display device with an operating unit and at least one data store, the offerable information being capable of being transmitted from the data store to and displayed at the display device with the operating unit in the form of different information types respectively designated by different symbols. At least one information type has a evaluation allocated to it and its corresponding symbol has a discriminator allocated to it that indicates the evaluation that is allocated to the corresponding information type.

### BACKGROUND OF THE INVENTION

1. Field of the Invention

The invention is directed to a device for offering information of that type having at least one display device with operating unit, at least one data store containing information to be offered, a network with which a connection can be set up between the display device with the operating unit, and between the display device and the data store, and via which the information to be offered can be transmitted from the data store to the display device with the operating unit, whereby information to be offered can, in response to a corresponding actuation of the operating unit, be displayed on the display device as different types of information illustrated by different symbols.

2. Description of the Prior Art

Devices are known, for example PCs that access web sites in the world wide web (WWW) with a web browser, said web sites offering information in the form of different types of information illustrated by different symbols.

Many users consider it to be an inefficient use of time to identify those symbols which must be activated to obtain information the user considers relevant. The operation is often made even more difficult if other symbols to which information elements are allocated are situated behind a first symbol.

### SUMMARY OF THE INVENTION

An object of the present invention is to provide a device of the type initially described wherein the operation of the device by a user is simplified.

This object is inventively achieved in a device of the type described above wherein a evaluation is allocated to at least one type of information, whereby a discriminator is allocated to the illustration of at least one symbol corresponding to a type of information with evaluation and is presented on the display device, indicating the evaluation that is allocated to the corresponding type of information.

Operation is facilitated in the inventive device since the symbol behind which relevant information is to be found can be immediately recognized on the basis of the discriminator illustrating the respective evaluation.

In a preferred embodiment of the invention, a description of the type of information is displayed by activating the appertaining symbol with the operating unit. This description can be any of a table, a diagram, a text and/or an image.

In order to be able to preserve the surveyability given a large quantity of information, in a version of the invention the description corresponding to the type of information is formed by information elements in the form of at least one sub-symbol whereby an information sub-element of the information element is allocated to the sub-symbol. Hierarchic structure of sub-symbols can also be provided.

Similar to the symbols, a evaluation is allocated to at least one information element, and a discriminator is allocated to at least the sub-symbol corresponding to an information element with the evaluation, the discriminator indicating what evaluation is allocated to the corresponding information element. As in the case of sub-symbols, it is thus assured that the information relevant for the user can be quickly and simply found on the basis of the evaluation. Also as in the case of the symbols, the information corresponding to an information element can be displayed in a simple way by activating the appertaining sub-symbol with the operating unit.

As in the case of the sub-symbols, the information corresponding to the information element belonging to a sub-symbol is any of a table, a diagram, a text, an image, sound and/or a video sequence.

In a preferred version of the invention the device automatically undertakes the evaluation for at least one type of information and/or for at least one information element on the basis of a quantitative analysis. According to further versions of the invention, the quantitative analysis can be based on a threshold that can be entered via the operating unit and/or on a reference trend curve that can be entered via the operating unit.

Alternatively, the evaluation can ensue by a user allocating a evaluation level from a number of given evaluation levels to at least one type of information and/or to at least one information element via the operating unit.

In a preferred embodiment of the invention, the discriminator is any of a color, a shape, an image, a pictogram, a scale and/or an alphanumerical character. In this way, it is assured that the evaluation is indicated in a way that is well-adapted to the information to be respectively weighted and in a way that can be simply recognized.

In an embodiment of the invention addresses for information to be offered and that indicate the memory location in the respective data store are deposited in a table or data bank that can be edited with the operating unit. Given modifications and/or relocating of the information to be offered, it is thus easy to undertake the required modifications in order to continue to enable the correct display of information to be offered. The description corresponding to a type of information and/or to an information element can be updated at any time by activating the corresponding symbol and/or sub-symbol, for example by reading the address corresponding to the description from the table or data bank, and the corresponding information is called anew from the respective data store and is displayed on the display device.

In a preferred embodiment of the invention, at least a part of the information is formed by standard software datafiles and/or office software datafiles, so that it is not necessary to put the information into a new form; rather, those datafiles wherein the information is usually presented can be accessed. In this context, a standard software datafile and/or office software datafile is opened for the presentation of the corresponding information—whether by means of the application corresponding to the datafile or by means of a suitable viewer—so that the presentation of the information ensues in the customary way. There is also the possibility to image only the information corresponding to a standard software datafile and/or office software datafile for presentation, i.e., for example, by converting a table produced with a text processing program into an HTML table, which is displayed.

The inventive device can be realized with especially low outlay when the display device with operating unit is a commercially available computer, particularly a personal computer (PC).

In a version of the invention information to be offered can be supplied into at least one data store by correspondingly authorized users. In this way, it is assured that the critical information to be offered cannot be modified in an unauthorized way.

In order to be able to quickly update less critical information to be offered that changes frequently, in a version of the invention appropriately authorized users enter offerable information into at least one data store via the operating unit.

In a preferred embodiment of the invention the network is the WWW, whereby the term WWW means both generally accessible areas of the WWW (Internet) as well as areas (Intranet) accessible to limited groups of people, as well as wireless and hardwired data transmission.

The inventive device is preferably employed for the presentation of business-relevant data, particularly in a management information system.

### DESCRIPTION OF THE DRAWINGS

FIG. 1 is a block circuit diagram of the inventive device.

FIGS. 2-8 illustrate various display screen presentations that occur in the operation of the device according to FIG. 1.

### DESCRIPTION OF THE PREFERRED EMBODIMENTS

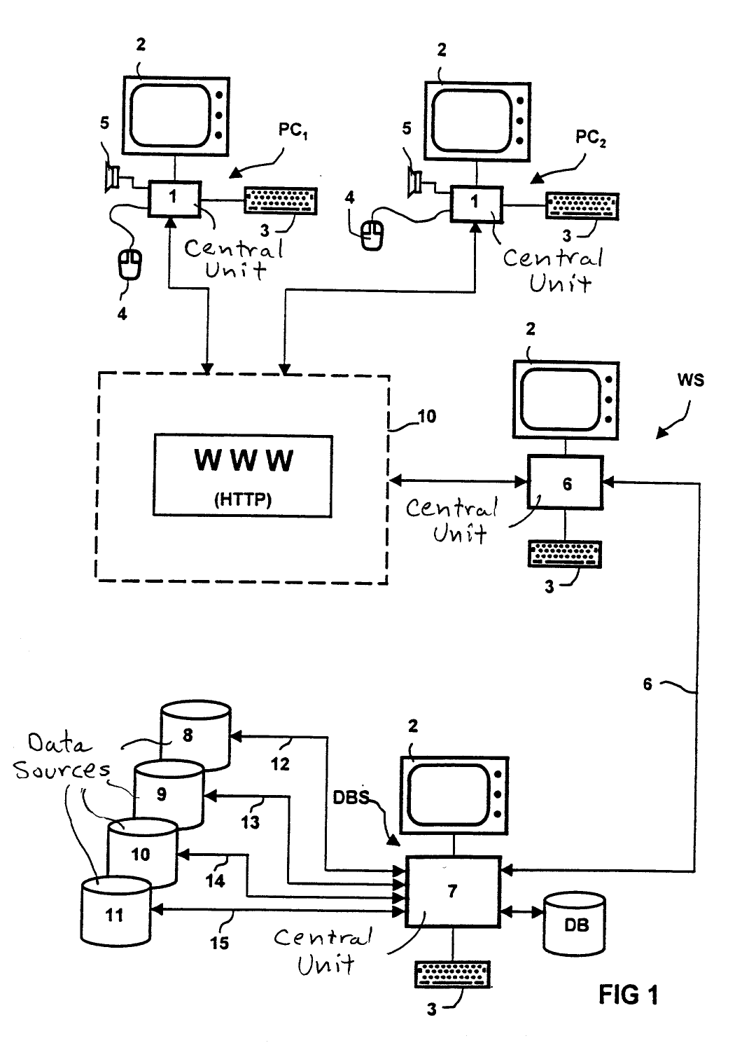

In the exemplary embodiment according to FIG. 1, the inventive device has two display devices with respective operating units, which are commercially available computers PC₁ and PC₂ in the illustrated exemplary embodiment. The computers PC₁ or PC₂ each have a central unit 1, a monitor 2 as well as keyboard 3 and mouse 4, and a speaker 5, so that audio signals (sounds) can be reproduced. Software that serves the purpose of fetching and presenting offerable information can be run on the computers PC₁ and PC₂. The inventive device also has at least one data store, such as a web server WS and a data bank server DBS, for example an SQL server, connected thereto via a network connection 6, the offerable information being stored in the data bank DB of the data bank server DBS.

In the described exemplary embodiment, the web server WS and the data bank server DBS respectively have a central unit 6 and 7 with a keyboard 2 and a monitor 3.

The web server WS communicates in two respects with the data bank server DBS via the network connection 6.

First, an application installed on the web server WS can be used to determine what information is stored in the data bank DB of the data bank server, whether such information is supplied to the data bank DB by the web server WS or the web server WS initializes the data bank server DBS to fetch corresponding information from data sources 8 through 11 and store this on the data bank DB.

The data sources 8 through 11 connected to the data bank server DBS via network connections 12 through 15 can be data sources of different types, for example the database of industrial management software, for example SAP®, Oracle®, SQL or Access® data banks or data offered by calculation programs such as, for example, Excel®.

Second, the web server WS communicates with the data bank server DBS in such a way that the web server WS in turn fetches information from the data bank DB called by the computer PC₁ or PC₂ and makes it available to the computers PC₁ and A network is provided for this purpose that connect the computers PC₁ and PC₂ to the data store, namely the web server WS thereof. In the described exemplary embodiment, the network is formed by the world wide web WWW, whereby the information exchange between the respective computers PC₁ and PC₂ and the web server WS ensues according to the HTTP standard.

For this purpose, the application installed on the web server WS allows the information to be made available to the computers PC₁ and PC₂ to be fetched by the data bank server DBS via the web server WS. This application installed on the web server also produces a data bank or table that contains details about the storage locations of the offerable information on the data bank DB of the data bank server DBS.

The software installed on the computers PC₁ and PC₂ for fetching and presenting offerable information in the described exemplary embodiment is a web browser with suitable plugins. In the described exemplary embodiment, moreover, the software for fetching and presenting offerable information also includes an application written, for example, in Java that, together with the web browser and the plugins, implements or supports the functions described below. When, it is mentioned below that a specific function is executed, this means that the software initiates the respective computer PC₁ or PC₂ to become correspondingly active, if necessary in response to a corresponding actuation of the operating unit by a user.

The functionality of the inventive device is explained below for the case of the user starting the software on one of the computers PC₁ or PC₂ that serves for fetching and presenting offerable information, namely on the basis of the picture screen presentations that occur.

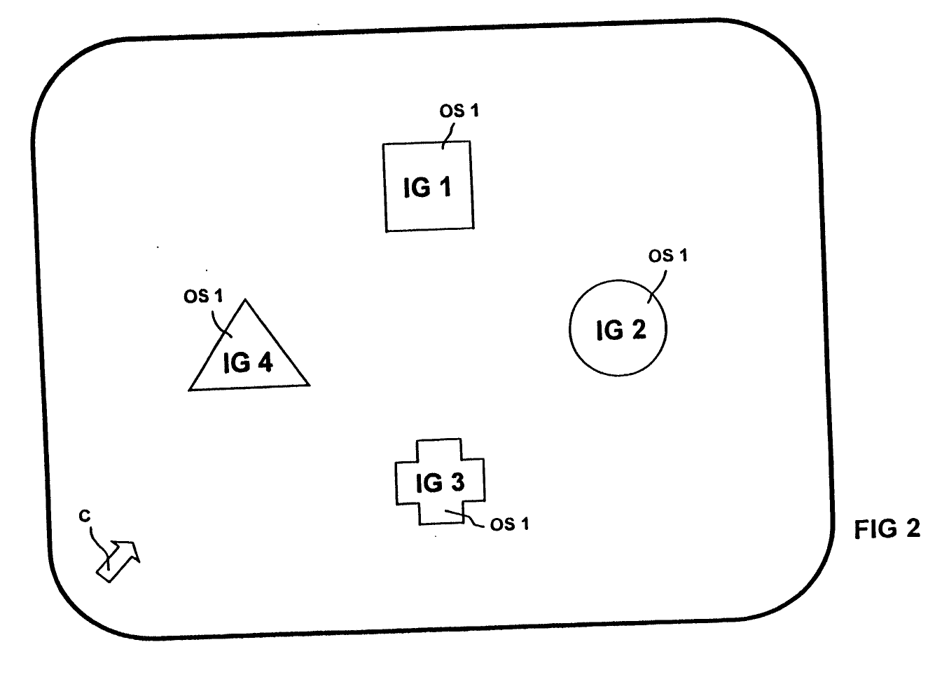

When the software serving for fetching and presenting offerable information is started on one of the computers PC₁ or PC₂, the web server WS sends information to the respectively computer PC₁ or PC₂ that causes the picture screen presentation according to FIG. 2 to appear on the monitor 2 of the respectively computer PC₁ or PC₂. This presentation includes a number of different super-symbols—four super-symbols OS 1 through OS 4 in the described exemplary embodiment—that illustrate different information groups IG 1 through IG 4. The super-symbols OS 1 and OS4 are Internet links behind which addresses of information stored on the web server WS reside.

When one of the super-symbols OS 1 through OS4 is activated, for example by a mouse pointer C being moved onto the corresponding super-symbol, for example the super-symbol OS 3, and a mouse click is carried out, then the web server WS sends the information stored under the corresponding address to the respective computer PC₁ or PC₂.

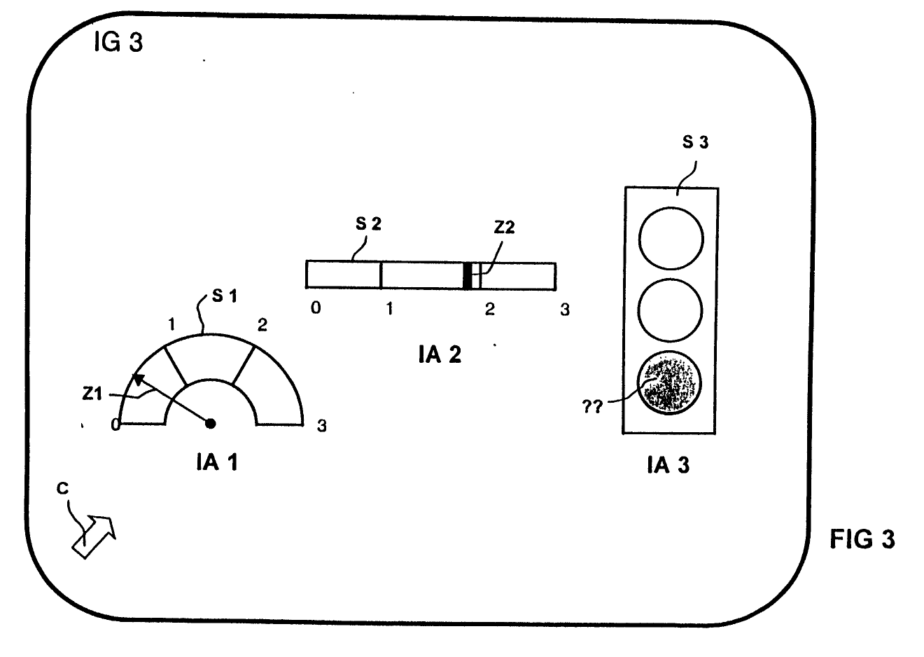

Following thereupon, the picture screen presentation on the monitor of the respective computer PC₁ or PC₂ changes, and the picture screen presentation according to FIG. 3 appears. This picture screen presentation initially reveals that it refers to the information group IG 3, as the particular in the upper left corner of the picture screen shows. Second, different information types IA 1 through IA 3 belonging to the information group 3 are illustrated by symbols S1 through S3. These information types respectively have a evaluation allocated to them that is illustrated by a corresponding discriminator allocated to the respective symbol S1 through S3.

In the case of FIG. 3, the discriminator is formed by a circular arc-shaped scale for the information type IA 1, by a linear scale for the information type IA 2, and by color for the information type IA 3. Thus the symbols S1 through S3 themselves are fashioned as a circular scale, linear scale or traffic signal, with the position of the pointers Z1 or Z2 on the scales of the symbols S1 and S2 or the light of the traffic signal of the symbol 3 that is respectively animated as being activated indicates the evaluation allocated to the respective information type IA 1 through IA 3.

On the basis of the discriminators, thus, a user is able to recognize how the individual information types IA I through IA 3 are weighted. A low value on the scales of the symbols S1 and S2 thereby corresponds to an unfavorable evaluation but a high value corresponds to a favorable evaluation, whereas the red light given the traffic signal of the symbol S3 corresponds to an unfavorable evaluation, the yellow light corresponds to a medium evaluation and the green light corresponds to a favorable evaluation.

Given the illustration of FIG. 3, a user can see at first glance that the situation with respect to the information type IA 1 is unfavorable, and thus possibly critical.

A more precise impression about the information type IA 1 can be acquired by the user moving the mouse pointer C onto the symbol SI and makes a mouse click, since the symbols S I through S 3 are Internet links behind which addresses of information stored both on the web server WS as well as on the data bank DB of the data bank server DBS likewise reside.

When one of the symbols S 1 through S 3 is activated, for example by the mouse pointer C being moved onto the symbol S 1 and a mouse click being carried out, then the web server WS fetches the information stored on the web sever WS itself or on the data bank DB of the data bank server DBS and sends this to the respective computer PC₁ or PC₂.

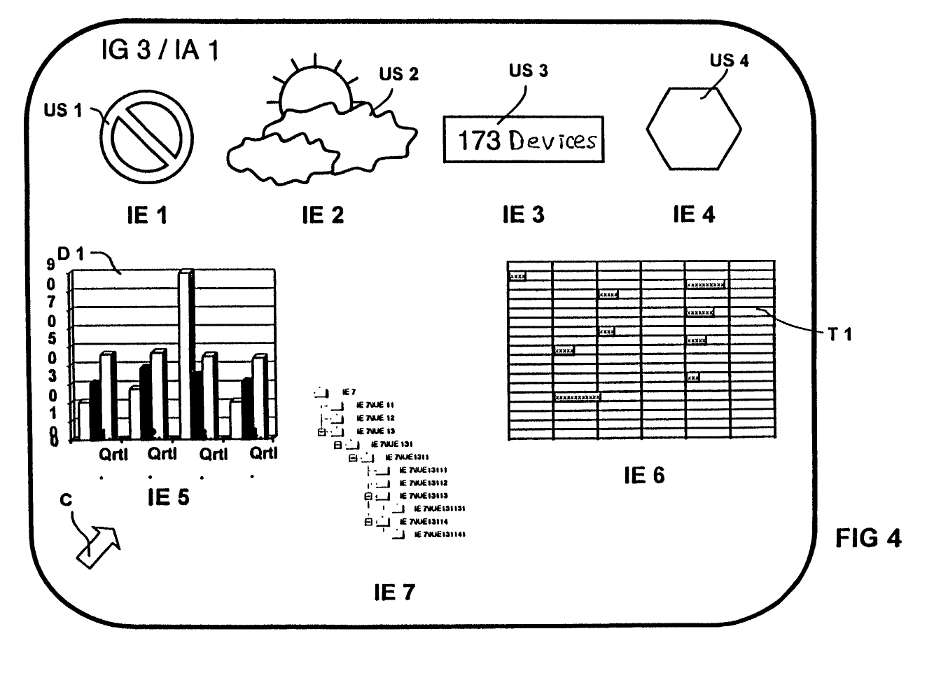

After receiving this information, the picture screen presentation according to FIG. 4 appears on the monitor 2 of the respective computer PC₁ or PC₂, it being initially recognizable from the picture screen presentation in the upper left corner of the picture screen that this is the information type IA 1 from the information group IG 3.

This information type is presented in the form of information elements IE 1 through IE 7, whereby the information elements IE I through IE 4 being sub-symbols US 1 through US 4 to which a respective information element IE 1 through IE 4 is allocated. In the case of the information elements IE 5 and IE 6, the corresponding information is shown as a document of an office software or industrial management standard software, namely as a diagram D 1 in the case of the information element IE 5 and as a table T 1 in the case of the information element IE 6.

Thus the user can immediately judge the corresponding information from the information elements IE 5 and IE 6 after the user has activated the symbol S1 and thus effected the transmission of the corresponding information from the data bank DB of the data bank server DBS to the respective computer PC₁ and PC₂.

Discriminators are allocated to the sub-symbols US 1 through US 4 (the corresponding information is stored on the web server WS) corresponding to the evaluation of the information sub-elements corresponding to these sub-symbols US 1 through US 4.

In the case of the sub-symbol US 1, the discriminator is formed as a pictogram, namely a traffic sign, whereby the type of displayed traffic sign indicates the evaluation.

In the case of the sub-symbol US 2, the discriminator is formed as an image, namely as an image of the sun, whereby the evaluation is more favorable the fewer clouds there are in front of the sun.

The discriminator in the case of the sub-symbol US 3 is formed as an alphanumerical character whose content directly corresponds to the evaluation.

In the case of the sub-symbol US 4, the discriminator is formed as the shape of the sub-symbol US 4, whereby the evaluation is more favorable the more closely the shape of the sub-symbol US 1 approaches the shape of a circle.

The information (this is stored on the web server WS) corresponding to the information element IE 7 is a hierarchic structure HS 1 of sub-symbols. In the described exemplary embodiment, the hierarchic structure HS 1 of sub-symbols is a presentation similar to a graphic directory structure known from computer technology. Since the sub-symbols of the hierarchic structure HS 1 are also Internet links behind which addresses of information stored on the data bank DB of the data bank server DBS likewise reside, the web server WS fetches the information elements corresponding to the sub-symbols from the data bank DB of the data bank server DBS and transmits these to the respective computer PC₁ or PC₂ when the corresponding sub-symbol, for example the sub-symbol IE 7/IUE131131, is activated with the mouse pointer C and a mouse click. The information corresponding to a sub-symbol can be a further sub-symbol stored on the web server WS or can be direct information, for example a table or a diagram, that is stored on the data bank DB of the data bank server DB.

When one of the sub-symbols US 1 through US 4 is activated, for example, by the mouse pointer C being moved to the sub-symbol and a mouse click being carried out, then the information stored under the corresponding address on the data bank DB of the data bank server DBS is fetched and transmitted to the respective computer PC₁ and PC₂.

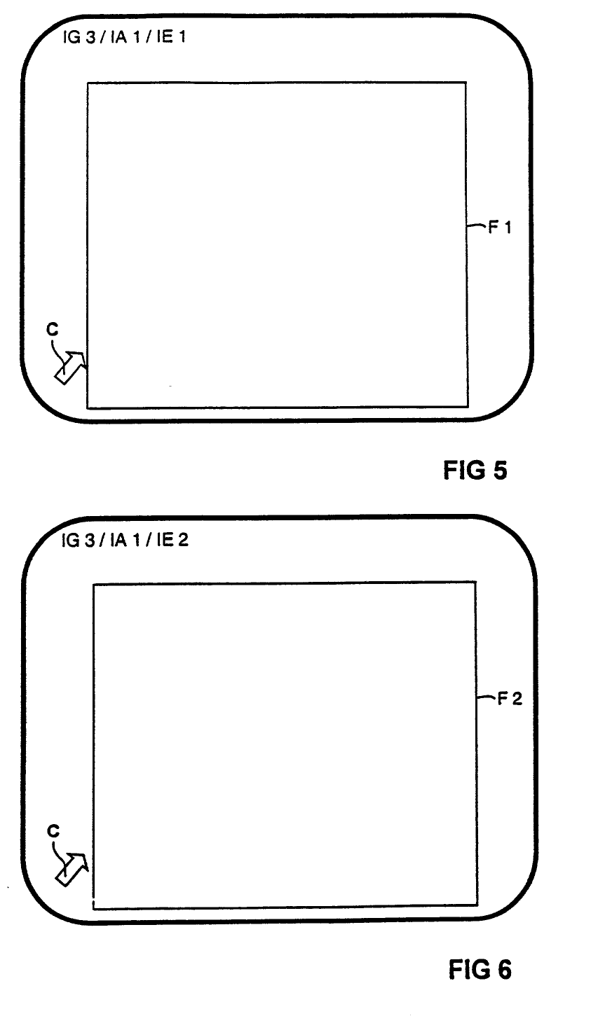

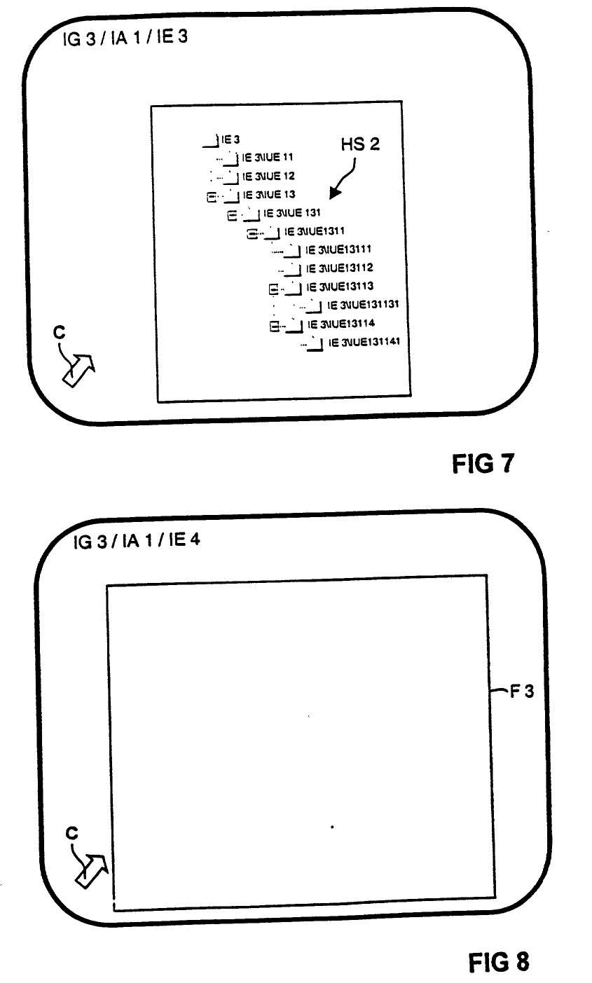

The information corresponding to the information elements IE 1 through IC4 that is fetched from the data bank DB of the data bank server given activation of the sub-symbols US 1 through US 4 and displayed on the computer PC₁ or PC₂ is shown in FIGS. 5 through 8. This is text in the case of the information element IE 1, for example a document produced with the text processing program of an office software, whereby only the frame F 1 within which the display of the document ensues is shown. This is an image in the case of the information corresponding to the information element IE 2, for example a bit map, whereby only the frame F 2 within which the display of the image ensues being shown for clarity. This is a further hierarchic structure HS 2 of sub-symbols analogous to FIG. 4 in the case of the information corresponding to the information element IE3, and a sound video sequence in the case of the information corresponding to the information element IE 4, whereby the display of the video image ensues in a frame F 3 on the respective monitor 2 and the playback of the audio signals ensues via the speaker 5.

When the offerable information, as in the case of the information elements IE 5 and IE 6 as well as the information sub-element IUE1, is a document of office software or of industrial management standard software, there is the possibility of displaying these documents by starting the corresponding standard software or a suitable viewer as a plugin. However, there is also the possibility of indirectly presenting the information corresponding to these documents by converting this information is converted into an HTML datafile and presenting it with the web browser.

The setting of the discriminators corresponding to the evaluation of the appertaining information ensues with the application installed on the web server WS and can only be performed by correspondingly authorized users, who must identify themselves, for example with a password, for this procedure. The authorized user can act directly at the web server WS or can access the web server WS via a network connection (in a way that is not shown).

In the operating mode corresponding to the setting of the discriminators, the authorized user can fetch the symbols and sub-symbols provided with discriminators and edit the corresponding information according to undertaken by the user or by a third party.

In the case of scale, for example, this occurs by the pointer being displaced with the mouse pointer C onto the position within the scale corresponding to the respective evaluation.

In the case of pictogram, shapes, colors, images, etc., the user is offered a selection respectively corresponding to one of the evaluation levels, for example a plurality of suns having different degrees of cloud cover in addition to the sun without clouds in the case of the sub-symbol US 2, the user selecting the illustration corresponding to the respective evaluation therefrom with the mouse pointer C on the basis of a mouse click.

The symbols and sub-symbols edited or selected by the authorized user and provided with discriminators are stored on the web server WS. From the moment of storage, the symbols and sub-symbols provided with the modified discriminators being transmitted to the computers PC₁ and PC₂ insofar as they are fetched therefrom, such as by starting the software serving for fetching and presenting offerable information on the computer PC₁ or PC₂, or such as by corresponding operating actions at the computer PC₁ or PC₂.

Alternatively or in addition to the described setting of the discriminators by an authorized user, it can also be provided that the inventive device—the web server WS in the described exemplary embodiment—automatically undertakes a quantitative analysis of the information on the data bank DB of the data bank server DBS by means of the application installed on it and correspondingly sets the discriminators of the symbols and sub-symbols.

This automatic quantitative analysis is based on thresholds and/or reference trend curves that can be entered via the operating unit for the respective information. The thresholds and/or reference trend curves on which the automatic quantitative analysis is based can be entered by an appropriately authorized person.

Authorized users can enter the offerable information via the WWW. The software loaded onto the computers PC₁ and PC₂ offers appropriate possibilities for this. This type of input is especially suited for offerable information that is less critical and that changes frequently. For security reasons, storage is only carried out in the web server WS or at most on the data bank DB of the data bank server DBS.

As a result of the discriminators, the inventive device allows a user to navigate through the offerable information in a simple way and to select information especially relevant for the user on the basis of the evaluation.

The inventive device is especially suited for the presentation of business information in the form of a management information system. In this case, the information groups allocated to the super-symbols OS 1 through OS4 are, for example, the information groups finances, customers/market, employees/innovation and internal processes, and the information elements and/or information sub-elements allocated to these information groups are scorecards and/or characteristic quantities.

The described exemplary embodiment provides only two display devices with operating units, namely the computers PC₁ and PC₂. It is self-evident that only a single display device with an operating unit or more than two display devices with respective operating units can be present in the framework of the invention. When a number of display devices with operating units are present, each user has the possibility of simultaneously accessing offerable information.

Differing from the exemplary embodiment, wherein the web server WS accesses a single data bank server DBS, a number of data bank servers can be provided.

The use of four data sources 8 through 11 provided in the described exemplary embodiment is to be understood as only an example. In practice, the number of data sources can be higher or lower.

The fashioning of the data store provided in the described exemplary embodiment also is only an example. Thus, for example, the data bank server can be omitted and the storage of the offerable data can ensue directly on the web server.

In the described exemplary embodiment, the display devices with operating units are formed by computers PC₁ and PC₂, however, there is also the possibility within the framework of the invention of employing other display devices with respective operating units, for example mobile telephones that are Internet-compatible.

When the WWW is used as the network, the possibility of communicating directly with the data bank server DBS by modem or the like can be provided for special instances wherein no Internet access is available. To this end, however, software must be installed on the computer, for example a notebook that is to communicate with the data bank server DBS, that simulates the presence of an Internet access in that it makes the same picture screen presentations and functionalities as described above available to the user.

For administration purposes as well as for data maintenance and updates, appropriately authorized users can be granted a direct access to the web server WS and the data bank server DBS in a way that is not shown, namely by bypassing the WWW with the authorized user acting directly on site at the web server WS, or the data bank server DBS or communicates with the web server WS or the data bank server DBS via a suitable network connection.

The world wide web WWW serves as the network in the described exemplary embodiment. The employment of other or additional networks, for example LAN and/or WAN, is possible within the framework of the invention. This may require a software that, differing from the described exemplary embodiment, is not software based on a web browser, but is a client-server application.

In the above description of the exemplary embodiment, it was noted only at certain points that certain functions are only accessible to certain users. In general, however, users who wish to use the inventive device must identify themselves, for example by user name and/or password, and only can use the individual functions when such persons are appropriately authorized.

Although modifications and changes may be suggested by those skilled in the art, it is the intention of the inventors to embody within the patent warranted hereon all changes and modifications as reasonably and properly come within the scope of their contribution to the art.

We claim as our invention:

1. A device for offering information, comprising:
a display device with an associated operating unit;
a data store containing information to be offered;
a network allowing a connection to be set up between the display device with the associated operating unit and said data store, via which said information is transmitted from said data store to said display device with the associated operating unit; and
said display device with the associated operating unit being programmed, in response to actuation of said operating unit, to display said information at said display device as a plurality of different information types respectively designated by respective different symbols, with at least one of said information types having a evaluation allocated thereto, and said display device with the associated operating unit further being programmed to display a discriminator at said display device allocated to at least one of the displayed symbols, said discriminator providing a visual indication of the evaluation allocated to the information type designated by said at least one of said symbols.

2. A device as claimed in claim 1 wherein said display device with the associated operating unit is programmed to display said information type by activating, via said operating unit, the symbol designating that information type.

3. A device as claimed in claim I wherein, for at least one of said symbols, the information type designated by said at least one of said symbols is selected from the group consisting of tables, diagrams, texts, images, sound and video sequences.

4. A device as claimed in claim 1 wherein, for at least one of said symbols, the information type designated by said at least one of said symbols comprises a plurality of information elements, and wherein said display device with the associated operating unit is programmed to display a plurality of sub-symbols, respectively designating said information elements.

5. A device as claimed in claim 4 wherein said sub-symbols have a hierarchic structure.

6. A device as claimed in claim 5 wherein at least one of said information elements has a evaluation allocated thereto, and wherein said display device with the associated operating unit is programmed to display a discriminator allocated to the respective sub-symbol designating said at least one information element with said evaluation, said discriminator indicating the evaluation allocated to said at least one information element.

7. A device as claimed in claim 4 wherein the respective information elements have informational content, and wherein said display device with the associated operating unit is programmed to display the informational content allocated to a respective information element by activating, via said operating unit, the respective sub-symbol designating that information element.

8. A device as claimed in claim 4 wherein said informational elements have respective informational contents associated therewith, said informational contents being selected from the group consisting of tables, diagrams, texts, images, sounds and video sequences.

9. A device as claimed in claim 1 wherein said display device with the associated operating unit is programmed to automatically weight at least one of said information type and said information element dependent on a quantitative analysis.

10. A device as claimed in claim 9 wherein said display device with the associated operating unit is programmed to make a quantitative analysis dependent on a threshold entered via said operating unit.

11. A device as claimed in claim 9 wherein said display device with the associated operating unit is programmed to make a quantitative analysis dependent on a reference trend curve entered via said operating unit.

12. A device as claimed in claim 9 wherein said display device with the associated operating unit allows a user-entered allocation of said evaluation to at least one of said information type and said information element, as an evaluation class selected from a number of predefined evaluation classes.

13. A device as claimed in claim 1 wherein said display device with the associated operating unit displays said discriminator with a visual indicator of said evaluation selected from the group consisting of color, shape, image, pictogram, scale and alphanumeric characters.

14. A device as claimed in claim 1 wherein said offerable information has an address indicating a storage location of said offerable information in said data store, and wherein said display device with the associated operating unit is programmed to display an identification of said address and to allow editing thereof.

15. A device as claimed in claim I wherein each of said information types has an informational content associated therewith, and wherein said display device with the associated operating unit is programmed to allow updating of the informational content of an information type by activating the respective symbol designating that information type.

16. A device as claimed in claim I wherein said offerable information is a datafile selected from the group consisting of standard software datafiles and office software datafiles.

17. A device as claimed in claim 16 wherein said display device with the associated operating unit is programmed to open said datafile upon activation, via said operating unit of the respective symbol designating that information type.

18. A device as claimed in claim 17 wherein said display device with the associated operating unit displays said datafile after said datafile is opened.

19. A device as claimed in claim 1 wherein said display device with the associated operating unit is a personal computer.

20. A device as claimed in claim 1 wherein said display device with the associated operating unit is programmed to allow said offerable information to be supplied thereto from said data store only in response to an entry via said operating unit by an authorized user.

21. A device as claimed in claim 1 wherein said display device with the associated operating unit is programmed to allow entries to be made, via said operating unit, to augment said offerable information in said data store.

22. A device as claimed in claim 1 wherein said network is the worldwide web.

23. A device as claimed in claim 1 wherein said data store is a data store in which business data are stored as said offerable information.

24. A device as claimed in claim 1 wherein said data store is a data store wherein management information is stored as said offerable information.
